(19) United States
(12) Patent Application Publication
(10) Pub. No.: US 2005/0223347 A1
(43) Pub. Date: Oct. 6, 2005

(54) Automatic LVS rule file generation apparatus, template for automatic LVS rule file generation, and method for automatic LVS rule file generation

(75) Inventor: Katsumi Okuaki, Tokyo (JP)

Correspondence Address: FOLEY AND LARDNER;SUITE 500, 3000 K STREET NW, WASHINGTON, DC, 20007, US

(73) Assignee: Elpida Memory, Inc.

(21) Appl. No.: 11/093,100

(22) Filed: Mar. 30, 2005

(30) Foreign Application Priority Data
Mar. 31, 2004 (JP) 2004-105126

(51) Int. Cl. G06F 17/50

(52) U.S. Cl. 716/5

(57) ABSTRACT

An automatic LVS rule file generation apparatus includes a definition file generating unit and a rule file generating unit. The definition file generating unit generates definition files used for a layout verification based on first data and templates that are used for the layout verification in a layout design of a semiconductor apparatus. The rule file generating unit automatically generates a LVS rule file based on the definition rule files. The templates includes first parameters indicating three-dimensional structures of the semiconductor apparatus. The definition files includes second data with respect to the first parameters.

### BACKGROUND OF THE INVENTION

1. Field of the Invention

The present invention relates to an automatic LVS (layout versus schematic) rule file generation apparatus, a template for an automatic LVS rule file generation and a method for an automatic LVS rule file generation. More specifically, the present invention relates to an automatic LVS rule file generation apparatus, a template for an automatic LVS rule file generation, and a method for an automatic LVS rule file generation that facilitate extraction of a parasitic element in a semiconductor circuit.

2. DESCRIPTION OF THE RELATED ART

It is well known that one of layout design processes replaces a net list (a circuit schematic) with mask patterns which is used in the manufacture of the LSI circuit, in the designing of an LSI circuit. In the recent layout design processes, verification of electrical connectivity between a layout and the circuit schematic is carried out by using a commercial or an in-house LVS software. As LSI become fabricated finer, elements such as parasitic capacitors and/or parasitic resistors to be added to interconnections of the LSI should be extracted precisely in detail (actual-load extraction). Such actual-load extraction is carried out by using a commercial or an in-house LPE (layout parasitic extraction) software.

In the case of mere execution of the LVS verification, only electrical connectivity between the layout and the circuit schematic is checked. Therefore, for example, in the case of the same conductors of a polysilicon, a gate portion of a transistor element, a polysilicon portion of a capacitor element, and a polysilicon portion of an interconnection do not need to be separated from one another in logic type. However, when execution of actual-load extraction, even in the case of the same conductors of the polysilicon, the gate portion of the transistor element, the polysilicon of the capacitor element, the polysilicon portion of the interconnection are different from one another in three-dimensional structure. Therefore, their parasitic capacitance values are different from one another. Hence, the logic types thereof should be clearly separated from one another considering the three-dimensional structures, before the LVS verification, which is a previous step of the actual-load extraction, is executed. For the same reason, also for VIAs or contacts, the logic types thereof should be clearly separated from one another considering the three-dimensional connections, so that even when an upper base material is the same and a lower base material is different.

In this case, situations described below take place.

(1) Two operations of the LVS verification need to be executed. Here, the one operation of the LVS verification is executed to check only electrical connectivity between a circuit schematic and a layout, and the other operation of the LVS verification is executed as a preprocess of the actual-load extraction, i.e., LPE. This causes excessive work hours.

(2) Modifications more significant than the LVS verification that checks only the electrical connectivity between the circuit schematic and the layout need to be performed by taking the three-dimensional structure into consideration, in the case of execution of the LVS verification as the preprocess for the execution of the actual-load extraction, i.e. LPE.

In order to solve these problems, there are demands for techniques that efficiently generate an LVS rule file considering the three-dimensional structures and that cause the generated LVS rule file to effectively function for the actual-load extraction.

A layout designing side generates a template explicitly representing ion implantation regions reflecting actual wafers and the types of transistor elements that are determined based on the types of the ion being implanted. In the case of the generation of an actual LVS rule file, the file is generated with reference to the template, regardless of the verification tool. However, items other than transistor elements are not represented in an existing template in the present state. Therefore, for the generation of LVS rule files, there are demands for technique that enable wide use of such templates.

In conjunction with the above description, Japanese Laid Open Patent Application JP-A-Heisei 10-63699 discloses an automatic generation apparatus for semiconductor design verification rule files. The automatic generation apparatus for semiconductor design verification rule files is characterized by including an input means and a transforming means. The input means performs character input of data necessary to generate a rule file for performing a design-rule verification of a semiconductor layout design. The transforming means translates the input data into a data according to a grammar of the rule file. The data may include layer names of verification object graphical patterns, widths of the verification object graphical patterns, intervals among the verification object graphical patterns, verification values thereof. Usage of three-dimensional device element data is not disclosed in this application.

In conjunction with the above description, Japanese Laid Open Patent Application JP-A-Heisei 09-288686 discloses a layout pattern design criteria/verification rule generation support method and a system thereof. The method is characterized by including six steps. In the first step, layout pattern design criteria corresponding to a plurality of processes are inputted to the layout pattern design criteria/verification rule generation support system, thereby storing the data of the layout pattern design criteria in a database. In the second step, data necessary to create DRC rules for being used to check a layout pattern based on the layout pattern design criteria stored in the database are inputted to a DRC rule file generator module, thereby to generate a DRC rule file. In the third step, by referencing the layout pattern design criteria and the generated DRC rule file, data regarding a circuit elements are inputted to an LVS circuit extraction rule file generator module, thereby to generate an LVS circuit extraction rule file for being used to retrieve connection information of the circuit elements from the layout pattern. In the forth step, by referencing the layout pattern design criteria, data, which is necessary to generate a mask pattern data automatic generation formal file for generating a layout mask pattern data of the circuit elements from layout symbol data representing images of the circuit elements, are inputted to a master pattern data automatic generation formal file generator, thereby to generate the mask pattern data automatic generation formal file. In the fifth step, by using the generated mask pattern data automatic generation formal file, mask pattern data generated from the symbol data, thereby to verify whether or not the mask pattern data automatic generation formal file is valid. In the sixth step, by referencing the layout pattern design criteria, layout symbol data of the circuit elements are inputted to a parameterized cell generator module, thereby to generate a layout cell library for being used to configure a layout by using the layout symbol data.

In conjunction with the above description, Japanese Laid Open Patent Application JP 2000-268077 A discloses a method of an element recognition of a layout data required at a time of verification with the tool which performs layout verification of a semiconductor integrated circuit. At least one side of each of graphic patterns arranged at one layer as recognition patterns touches another at least one side of each of graphic patterns arranged at another layer as recognition patterns through the two layers. Different layout structures are arranged to different graphic pattern with different numbers of tangent sides according to kinds of elements to generate the layout data. The element recognition is executed by extracting the graphic pattern from the layout data by using the number of tangent sides.

In conjunction with the above description, Japanese Laid Open Patent Application JP 2002-073721 A discloses a parallel processor for layout verification. The processor includes a division means, an equalization means and a verification means. The division means inputs and divides a rule file of layout verification, and generates a plurality of divided rule files. The equalization means equalizes the size of the plurality of divided rule files. The verification means carries out the layout verification by a parallel processing based on the equalized plurality of divided rule files and object file of the layout verification.

In conjunction with the above description, Japanese Laid Open Patent Application JP 2002-230070 A discloses a layout verification apparatus. The apparatus includes a layout verification means. The layout verification means carries out a layout verification operation based on a necessary item rule file having a list in which only items to be verified among all items of verification rules in a layout database are listed. The necessary item rule file is generated by a check-item-of-rule-file-setting means which sets only contents related to the necessary items of the layout verification rules.

In conjunction with the above description, Japanese Laid Open Patent Application JP 2003-281123 A discloses an electronic application creating tool which computerizes the format of an application using a markup language. The tool includes a design-specifications read section, a tag information extracting section, a data structure generating section, a document type definition generating section, an attribute information extracting section, a database, a standard template extracting and a check rule file outputting section. The design-specifications read section reads design specifications. The tag information extracting section extracts tag information in the design specifications read by the design-specifications read section. The data structure generating section generates a data structure of an application based on the tag information based on the tag information. The document type definition generating section generates a document type definition corresponding to the markup language based on the tag information. The attribute information extracting section extracts attribute information in the design specifications read by the design-specifications read section. The database stores a check rule standard template beforehand. The standard template extracting section chooses from the database the check rule standard template corresponding to the attribute extracted by the attribute information extracting section. The check rule file outputting section outputs a check rule file which sets up an attribute parameter to the extracted standard template, combines the standard template, and checks a document.

In conjunction with the above description, Japanese Laid Open Patent Application JP H05-128208 A discloses a design rule check executing apparatus which checks whether a pattern layout data of a master slice are meeting a design criteria of a process method by using a design rule check executing rule file of the process method. The apparatus includes a plurality of means below. A means to extract a master slice use layer list from the pattern layout data. A means to generate a translation table for the master slices based on the extracted master slice use layer list and an original layer list newly defined different from multilayer. A means to specify a design rule check executing rule file of the process method corresponding to the pattern layout data. A means to generate a design rule check executing rule file for the master slices based on the specified design rule check executing rule file and a translation table for master slices. A means to perform a design rule check to the pattern layout data by using the generated design rule check executing rule file for the master slices.

In conjunction with the above description, Japanese Laid Open Patent Application JP H06-290233 A discloses a layout verification apparatus which inputs a layout pattern data of a circuit and verifies dimensions of each part. The apparatus includes a plurality of means below. A means to extract conditions which should be verified from a netlist for a circuit simulation. A means to generate a rule file for carrying out dimension verification based on the extracted conditions. A means to extract grouped elements which have relation in each of the above-mentioned conditions which should be verified from the above-mentioned netlist. A means to add information that grouping was carried out to the layout pattern data corresponding to the extracted element group. A verification means to perform the dimension verification corresponding to each element group based on the above-mentioned rule file.

In conjunction with the above description, Japanese Laid Open Patent Application JP H07-129648 A discloses a method of a layout verification. The method includes the step of constituting an object from graphic patterns based on object definition information, and indicating an error of the graphic patterns form which the object were not constituted.

In conjunction with the above description, Japanese Laid Open Patent Application JP H08-334888 A discloses an apparatus which carries out a verification of a mask pattern data designed for obtaining a desirable device. The apparatus includes a plurality of means below. A means to read design mask-pattern data, a means to predict a device structure obtained from the mask pattern. A means to read a rule of a device structure for the desirable device. A means to verify whether the device structure satisfies the device structure rule. A means to display the verification result.

### SUMMARY OF THE INVENTION

Therefore, an object of the present invention is to provide an automatic LVS rule file generation apparatus, a template for an automatic LVS rule file generation and a method for an automatic LVS rule file generation that can generate an LVS rule file taking a three-dimensional structure into account.

Another object of the present invention is to provide an automatic LVS rule file generation apparatus, a template for an automatic LVS rule file generation and a method for an automatic LVS rule file generation that can generate an LVS rule file easily performing actual-load extraction.

Still another object of the present invention is to provide an automatic LVS rule file generation apparatus, a template for an automatic LVS rule file generation and a method for an automatic LVS rule file generation that are able to use a template useful for actual-load extraction when the LVS rule file is generated.

This and other objects, features and advantages of the present invention will be readily ascertained by referring to the following description and drawings.

In order to achieve an aspect of the present invention, the present invention provides an automatic LVS rule file generation apparatus including: a definition file generating unit and a rule file generating unit. The definition file generating unit generates definition files used for a layout verification based on first data and templates that are used for the layout verification in a layout design of a semiconductor apparatus. The rule file generating unit automatically generates an LVS rule file based on the definition rule files. The templates includes first parameters indicating three-dimensional structures of the semiconductor apparatus. The definition files includes second data with respect to the first parameters.

In the automatic LVS rule file generation apparatus, the three-dimensional structures may include at least one of three-dimensional structures of elements of the semiconductor apparatus and three-dimensional position relations among the elements.

In the automatic LVS rule file generation apparatus, the rule file generating unit may automatically generate the LVS rule file by translating the second data of the definition files into rules for the layout design.

In the automatic LVS rule file generation apparatus, the rule file generating unit may include a first defining unit, a pattern logical processing unit, a second defining unit and a comparing unit. The first defining unit selects second parameters of predetermined constitutional elements of the semiconductor apparatus from the first parameters, and defines the constitutional elements based on the second parameters. The pattern logical processing unit derives partial elements of the constitutional elements based on the definition files, and redefines the partial elements and the constitutional elements from which the partial elements are removed. The second defining unit defines electrical connections among the redefined partial elements and the redefined constitutional elements. The comparing unit associates the redefined partial elements and the redefined constitutional elements with devices in circuit schematics of the semiconductor apparatus.

In the automatic LVS rule file generation apparatus, the first parameters may include third parameters regarding regions of ion implantation processes of the semiconductor apparatus and fourth parameters regarding devices of the semiconductor apparatus specified by the ion implantation processes.

In the automatic LVS rule file generation apparatus, the first parameters may include fifth parameters regarding conductor layers, master slice layers and text layers for LVS verification of the semiconductor apparatus.

In order to achieve another aspect of the present invention, the present invention provides a template for an automatic LVS rule file generation, wherein the template is used for generating an LVS rule file that indicates a rule for a layout verification of a layout design of a semiconductor apparatus, the template including: at least one of first parameter fields and second parameter fields, and third parameter fields. The first parameter fields are used for inputting data regarding three-dimensional structures of elements of the semiconductor apparatus. The second parameter fields are used for inputting data regarding three-dimensional position relations among the elements. The third parameter fields are used for inputting data regarding two-dimensional structures of elements of the semiconductor apparatus.

The template for an automatic LVS rule file generation, may further include fourth parameter fields and fifth parameter fields. The fourth parameter fields are used for inputting data regarding regions of ion implantation processes of the semiconductor apparatus. The fifth parameter fields are used for inputting data regarding devices of the semiconductor apparatus specified by the ion implantation processes.

The template for an automatic LVS rule file generation according to claim 7, may further include sixth parameter fields. The sixth parameter fields are used for inputting data regarding conductor layers, master slice layers and text layers for LVS verification of the semiconductor apparatus.

In order to achieve another aspect of the present invention, the present invention provides a method for an automatic LVS rule file generation including: (a) generating definition files used for a layout verification based on first data and templates that are used for the layout verification in a layout design of a semiconductor apparatus; and (b) generating automatically an LVS rule file based on the definition rule files. The templates includes first parameters indicating three-dimensional structures of the semiconductor apparatus. The definition files includes second data with respect to the first parameters.

In the method for an automatic LVS rule file generation, the three-dimensional structures may include at least one of three-dimensional structures of elements of the semiconductor apparatus and three-dimensional position relations among the elements.

In the method for an automatic LVS rule file generation, the step (b) may include (b1) generating the LVS rule file by translating the second data of the definition files into rules for the layout design.

In the method for an automatic LVS rule file generation, the step (b1) may include (b11) selecting second parameters of predetermined constitutional elements of the semiconductor apparatus from the first parameters, and defining the constitutional elements based on the second parameters, (b12) deriving partial elements of the constitutional elements based on the definition files, and redefining the partial elements and the constitutional elements from which the partial elements are removed, (b13) defining electrical connections among the redefined partial elements and the redefined constitutional elements, and (b14) associating the redefined partial elements and the redefined constitutional elements with devices in circuit schematics of the semiconductor apparatus.

In the method for an automatic LVS rule file generation, the first parameters may include third parameters regarding regions of ion implantation processes of the semiconductor apparatus and fourth parameters regarding devices of the semiconductor apparatus specified by the ion implantation processes.

In the method for an automatic LVS rule file generation, the first parameters may include fifth parameters regarding conductor layers, master slice layers and text layers for LVS verification of the semiconductor apparatus.

In order to achieve another aspect of the present invention, the present invention provides a computer-readable medium including code that, when executed, causes a computer to perform the following: (a) generating definition files used for a layout verification based on first data and templates that are used for the layout verification in a layout design of a semiconductor apparatus; and (b) generating automatically an LVS rule file based on the definition rule files. The templates includes first parameters indicating three-dimensional structures of the semiconductor apparatus. The definition files includes second data with respect to the first parameters.

In the computer-readable medium, the three-dimensional structures may include at least one of three-dimensional structures of elements of the semiconductor apparatus and three-dimensional position relations among the elements.

In the computer-readable medium, the step (b) may include (b1) generating the LVS rule file by translating the second data of the definition files into rules for the layout design.

In the computer-readable medium, the step (b1) may include (b11) selecting second parameters of predetermined constitutional elements of the semiconductor apparatus from the first parameters, and defining the constitutional elements based on the second parameters, (b12) deriving partial elements of the constitutional elements based on the definition files, and redefining the partial elements and the constitutional elements from which the partial elements are removed, (b13) defining electrical connections among the redefined partial elements and the redefined constitutional elements, and (b14) associating the redefined partial elements and the redefined constitutional elements with devices in circuit schematics of the semiconductor apparatus.

In the computer-readable medium, the first parameters may include third parameters regarding regions of ion implantation processes of the semiconductor apparatus and fourth parameters regarding devices of the semiconductor apparatus specified by the ion implantation processes.

In the computer-readable medium, the first parameters may include fifth parameters regarding conductor layers, master slice layers and text layers for LVS verification of the semiconductor apparatus.

### BRIEF DESCRIPTION OF THE DRAWINGS

FIG. 1 is a view showing the configuration of the embodiment of the automatic LVS rule file generation apparatus according to the present invention;

FIG. 2 is a view showing the configuration of an element definition file according to the present invention;

FIG. 3 is a table showing an example of a detailed configuration of an implantation region/transistor element definition file;

FIG. 4 is a table showing definitions of diode elements as an example of the detailed configuration of the three-dimensional element definition file for elements other than the transistor elements and the capacitor elements;

FIG. 5 is a table showing definitions of resistance elements as an example of the detailed configuration of the three-dimensional element definition file for elements other than the transistor elements, the capacitor elements, and diode elements;

FIGS. 6A, 6B and 7 are tables showing an example of a detailed configuration of three-dimensional contact connection definition files;

FIGS. 8 and 9 are tables showing an example of a detailed configuration of a conductive layer definition file;

FIG. 10 is a flowchart showing the operation of the embodiment of the automatic LVS rule file generation according to the present invention; and

FIG. 11 is a flowchart showing the operation in step S02.

### DESCRIPTION OF THE PREFERRED EMBODIMENTS

Embodiments of an automatic LVS rule file generation apparatus according to the present invention will be described below with reference to the attached drawings.

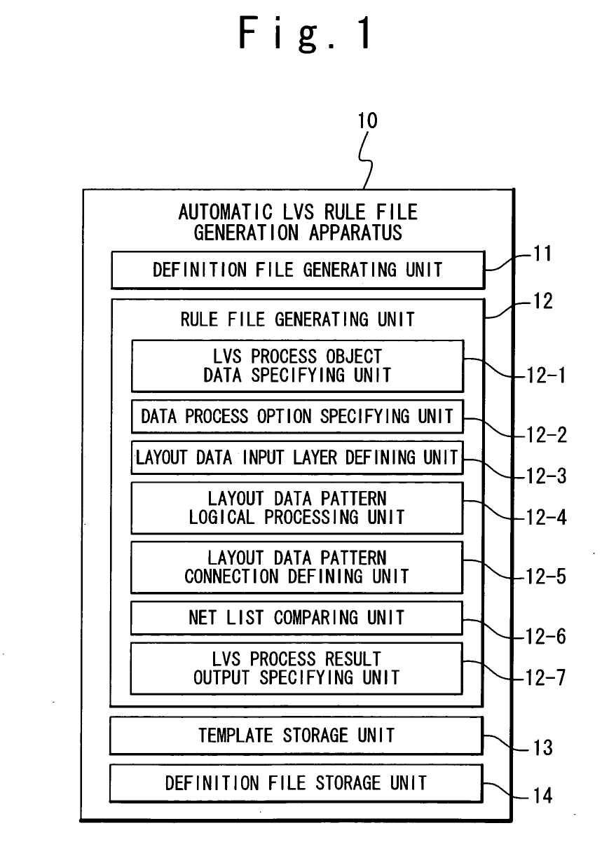

Firstly, the configuration of the embodiment of the automatic LVS rule file generation apparatus according to the present invention will be described with reference to the attached drawings. FIG. 1 is a view showing the configuration of the embodiment of the automatic LVS rule file generation apparatus according to the present invention. The automatic LVS rule file generation apparatus 10 generates an LVS rule file for actual-load extraction (exemplified: parasitic elements extraction) based on a template and a element definition file considering the three-dimensional structures. The automatic LVS rule file generation apparatus 10 is an information processing apparatus exemplified by a workstation. The automatic LVS rule file generation apparatus 10 includes a definition file generating unit 11 and a rule file generating unit 12, which are provided as programs, and a template storage unit 13 and a definition file storage unit 14.

The template storage unit 13 stores templates that are used to generate definition files. The template storage unit 13 is a programmable storage element exemplified by a hard disk drive (HDD), a random access memory (RAM), or a recording optical disk. The templates are exemplified by an ion implantation (hereinafter referred to as implantation) region/transistor element templates, three-dimensional element templates, three-dimensional contact connection templates, and conductive layer templates.

The definition file generating unit 11 displays a respective template, which is stored in the template storage unit 13, on a display device. Based on a user input to the displayed template, the definition file generating unit 11 generates an element definition file. The element definition files are exemplified by an implantation region/transistor element definition file, a three-dimensional element definition file, a three-dimensional contact connection definition file, and a conductive layer definition file.

The definition file storage unit 14 stores the respective element definition files generated by the definition file generating unit 11. The definition file storage unit 14 is a programmable storage element exemplified by a HDD, a RAM and a recording optical disk.

The rule file generating unit 12 translates respective parameters into respective LVS verification rules based on the definition files stored in the definition file storage unit 14 (or generated by the definition file generating unit 11), thereby to generate an LVS rule file. Thus, the rule file generating unit 12 serves as a automatic LVS rule file generation program.

The rule file generating unit 12 includes an LVS process object data specifying unit 12-1, a data process option specifying unit 12-2, a layout data input layer defining unit 12-3, a layout data pattern logical processing unit 12-4, a layout data pattern connection defining unit 12-5, a net list comparing unit 12-6, and an LVS process result output specifying unit 12-7.

The LVS process object data specifying unit 12-1 specifies constitutional elements used for the LVS verification with reference to a layout data and a circuit schematic data in response to the user input. The data process option specifying unit 12-2 specifies an option process for the data (the constitutional elements) that has been specified by the LVS process object data specifying unit 12-1.

The layout data input layer defining unit 12-3 selects a parameter of the predetermined constitutional element (exemplified: polysilicon) of a semiconductor device from a plurality of parameters based on the respective element definition file, thereby to define the constitutional element. The layout data pattern logical processing unit 12-4 derives a partial element (exemplified: a gate portion of a transistor element, a polysilicon portion of a capacitor element, or a interconnection portion) of the selected constitutional element based on the respective element definition file. Then, the layout data pattern logical processing unit 12-4 redefines the derived partial element and the constitutional element from which the derived partial element has been removed. The layout data pattern connection defining unit 12-5 defines electrical connections for the redefined partial element and constitutional element. The net list comparing unit 12-6 makes relation between the layout data and the circuit schematic data with respect to the constitutional elements.

The LVS process result output specifying unit 12-7 specifies a method and means for outputting the result of the LVS verification.

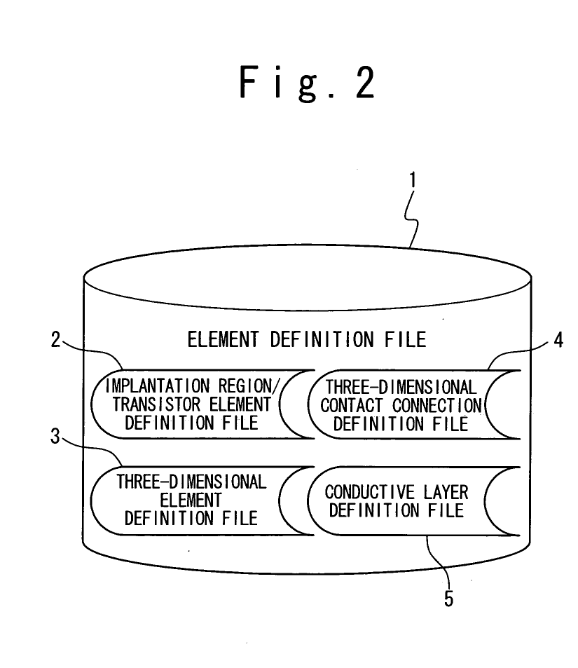

FIG. 2 is a view showing the configuration of an element definition file according to the present invention. The element definition file 1 is a group of element definition files considering the three-dimensional structures. The element definition file 1 includes an implantation region/transistor element definition file 2, a three-dimensional element definition file 3, a three-dimensional contact connection definition file 4, and a conductive layer definition file 5.

The implantation region/transistor element definition file 2 defines ion implantation regions reflecting an actual wafer, and all transistor element names (exemplified: PMOSs and NMOSs) and capacitor elements that are determined by the types of the ions implanted. The three-dimensional element definition file 3 defines three-dimensional structures (exemplified: resistance elements and diode elements) of device elements other than transistor elements and capacitor elements. The three-dimensional contact connection definition file 4 defines three-dimensional connections of elements such as VIAs and contacts. The conductive layer definition file 5 defines the types of conductive layers, master slice layers, and LVS text layers. The details of the definition files will be described below.

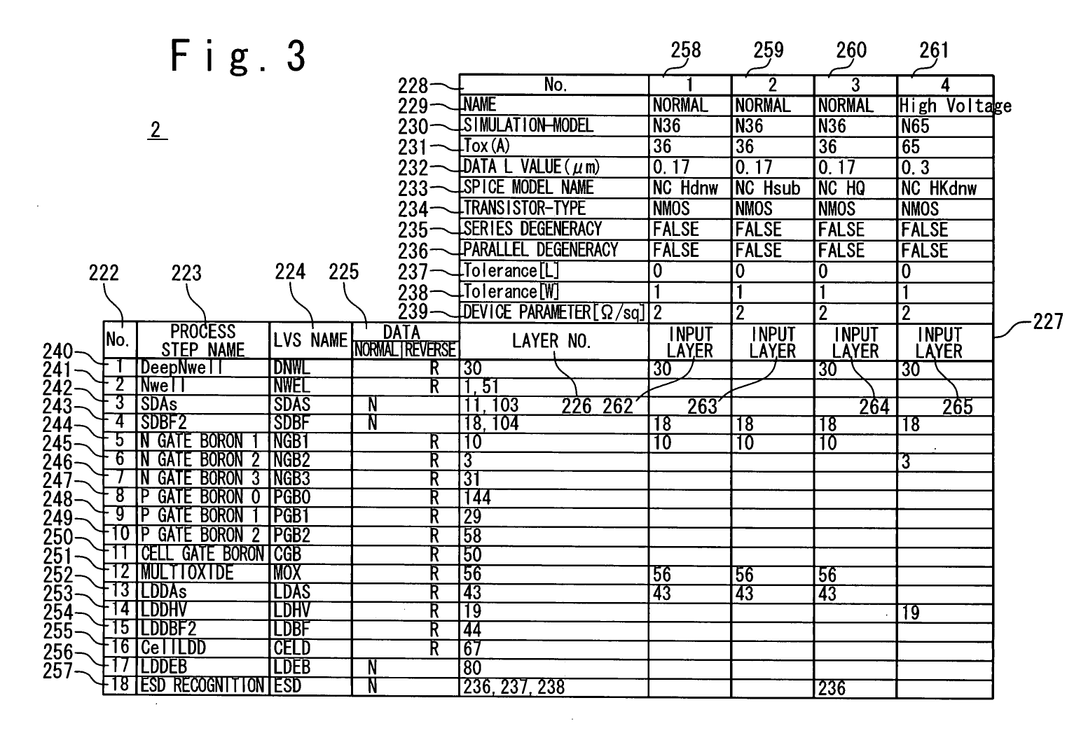

FIG. 3 is a table showing an example of a detailed configuration of an implantation region/transistor element definition file. In this case, a portion remaining after removal of practical data (such as names and numeric values) from this implantation region/transistor element definition file 2, represents the example of the implantation region/transistor element template.

The implantation region/transistor element definition file 2 defines seventeen implantation process steps (shown with numerals 240 to 256; and others thereafter are shown in the same manner), one transistor identification process step (257), and four types of transistor elements (258 to 261) regarding transistor elements. The implantation region/transistor element definition file 2 makes relations between data (222 to 227) regarding implantation regions and transistor elements (258 to 261).

A No. 222 is a heading, under which the following fields have numbers each identifying a process step for forming a transistor element. A process step name 223 is a heading, under which the following fields indicate names each identifying the process step. An LVS name 224 is a heading, under which the following fields indicate the names each used in the LVS rule file. A data 225 indicates whether or not the data of the respective process step normally shifts, when a reticle is manufactured. A layer No. 226 is a heading, under which the following fields indicate a layer number in the layout design corresponding to the respective process step. An input layer 227 is a heading, under which the following fields define the layer number when an input layer of a layout layer exists corresponding to the respective process step and the layout design is performed for a transistor element defined in fields of 228 to 239.

In the example of FIG. 3, it is defined that, for example, a Deep N well process step of No. 1 as an implantation process is a DNWL in the LVS rule file, the data is reversed when a reticle is manufactured, and it is a 30th layer in the layout data. The process steps sequentially to an LDDEB process step of No. 17 are implantation process steps. An ESD recognition of No. 18 as a transistor identification process step 257 is not an implantation process step, but is indicating that a recognition layer defined in the layout design exists to identify the transistor element. In this case, it is defined such that the ESD recognition is ESD in the LVS rule file, and the field 225 is the normal shift when the transistor identification process step not actually manufacturing a reticle, and it is defined such that the ESD recognition is formed in any layers of Layer No. 236, No. 237, and No. 238 in the layout data.

A No. 228 indicates a number that identifies the transistor element. A name 229, a simulation-model 230, a Tox (Å) 231, a data L value (μm) 232, respectively, indicate the name of the respective transistor element, a simulation-model name of the respective transistor element, an oxide film thickness (Å) of the respective transistor element, a gate length (μm) in the layout design of the respective transistor element. A spice model name 233 indicates a transistor model name of the respective transistor element in an LVS circuit spice. A transistor-type 234 indicates whether the transistor type is NMOS or PMOS. A series degeneracy 235 defines whether the transistor element is series-degenerated (TRUE) or not series-degenerated (FALSE) in the process of the LVS verification. A parallel degeneracy 236 defines whether the transistor element is parallel-degenerated (TRUE) or not parallel-degenerated (FALSE) in the process of the LVS verification. A tolerance (L) 237 is an allowable tolerance (%) being applied to a comparison between a gate length (L) dimension of the transistor of the circuit spice and a gate length (L) dimension of the transistor of the layout spice in the process of LVS verification. A tolerance (W) 238 is an allowable tolerance (%) being applied to a comparison between a gate width (W) dimension of the transistor of the circuit spice and a gate width (W) dimension of the transistor of the layout spice in the process of LVS verification. A device parameter (Ω/sq) 239 indicates a device parameter (Ω/sq) of a gate polysilicon.

In the example of FIG. 3, for example, the transistor element of No. 1 as a transistor element 258 is defined such that the name is NORMAL, the simulation-model name is N36, Tox of the transistor is 36 Å, the gate length (L) in the layout design is 0.17 μm, the spice model name is NC Hdnw, and the transistor-type is NMOS. For the transistor degeneracy in the process of the LVS verification, it is defined that the transistor is neither series-degenerated (235: FALSE) nor parallel-degenerated (236: FALSE). The allowable tolerance for the comparison between the gate length (L) of the transistor of the circuit spice and the gate length (L) of the transistor of the layout spice is specified to be 0%. The allowable tolerance for the comparison between the gate width (W) of the transistor of the circuit spice and the gate width (W) of the transistor of the layout spice is specified to be 1%. The device parameter of the gate polysilicon is defined to be 2 (Ω/sq). Thereafter, definitions are sequentially made up to transistor elements which is called High Voltage of No. 4 as a transistor element 261.

As described above, by using the implantation region/transistor element definition file, all the implantation process steps and the transistor-element identification process step and all the transistor types can be defined.

The following will describe a portion of a different implantation combination for every respective transistor type.

An implantation process step necessary to form the transistor element of No. 1 (the circuit spice model name 233: NC Hdnw) as the transistor element 258 is inputted to an input layer 262. That is, layers to be inputted as the layout data are defined with respect to the process steps from the DeepNwell process step as an implantation process step 240 to the ESD recognition process step as the transistor identification process step 257. In this case, a 30th layer for the DeepNwell process step as the implantation process step 240, a 18th layer for the SDBF2 process step as the implantation process step 243, a 10th layer for an N gate boron 1 process step as the implantation process step 244, a 56th layer for a multi-oxide process step as the implantation process step 251, and a 43rd layer for an LDDA process step as the implantation process step 252 are inputted as the layout data. Thereafter, input methods for layout data are sequentially defined up to the transistor element called High Voltage of No. 4 as the transistor element 261 with respect to an input layer 265.

In this case, the transistor elements (258 to 261) are defined. Capacitor elements to be determined based on the gate polysilicon and the types of ions being implanted may be defined. Thereby, element specification in the case of the actual-load extraction is facilitated. In this case, it is sufficient that the data (229 to 239) regarding the transistor elements are changed to parameters corresponding to the capacitor elements to be defined, and associations to process steps (240 to 257) of the implantation and the like are written as the input layers 227. In this manner, with the implantation region/device element definition files, all the implantation process steps and device-element identification process steps and the types of all the transistors and capacitor elements can be defined.

In the case of mere execution of the LVS verification, only the electrical connectivity between the circuit schematic and the layout is checked. In the above-described case, when the same polysilicon conductors are used, the gate portion of the transistor element, the polysilicon portion of the capacitor element and the polysilicon portion of the interconnection do not need to be separated in logic types from one another. That is, it is sufficient to define only one polysilicon for the polysilicon.

However, an important matter for executing the actual-load extraction is that even if the conductors are made of the same material, the parasitic capacitance values are different from one another when the three-dimensional structures are different from one another. Therefore, the logic types should be separated from one another. That is, in the LVS verification being executed before the actual-load extraction, even if the conductors are made of the same polysilicon, the gate portion of the transistor element, the polysilicon portion of the capacitor element and the polysilicon portion of the interconnection are different from one another in the three-dimensional structure and the parasitic capacitance value. Therefore, they should be separated from one another in the logic type. To accomplish the above, the definition described above is very effective, thereby to enable the logic types to easily be separated from one another.

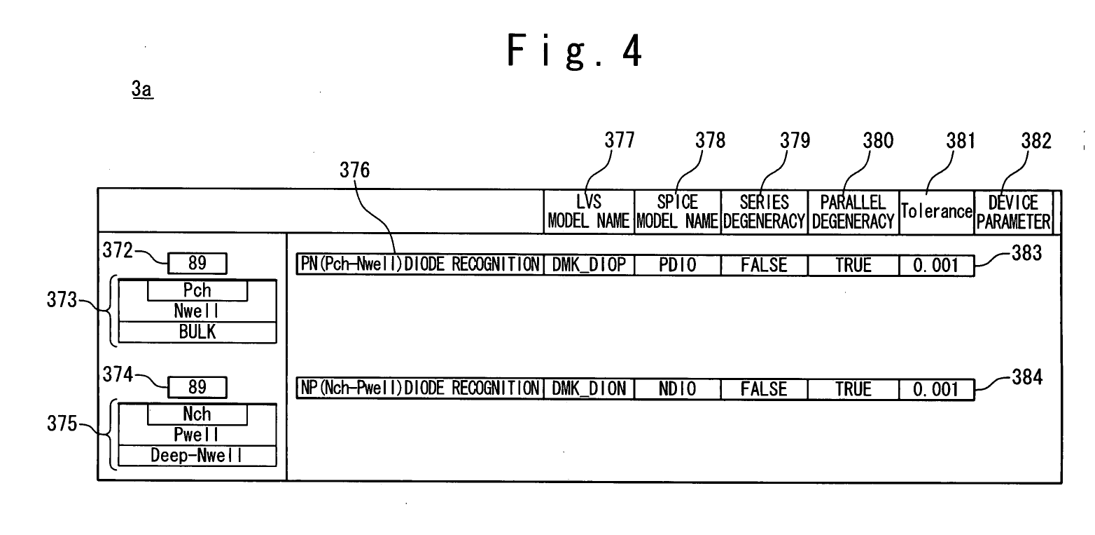

FIG. 4 is a table showing definitions of diode elements as an example of the detailed configuration of the three-dimensional element definition file for elements other than the transistor elements and the capacitor elements. In this case, a portion remaining after removal of practical data (such as names and numeric values) from the three-dimensional element definition file 3a represents the example of the template for the diode elements as three-dimensional elements.

In the three-dimensional element definition file 3a, a PN (Pch-Nwell) diode element and an NP (Nch-Pwell) diode element are defined. A recognition layer 372 is a recognition layer for recognizing the PN (Pch-Nwell) diode element in the layout design. A cross-sectional structure 373 is a schematic view showing a cross sectional structure of a semiconductor substrate with respect to the PN (Pch-Nwell) diode element. Similar to the above, a recognition layer 374 is a recognition layer for recognizing the NP (Nch-Pwell) diode element in the layout design. A cross-sectional structure 375 is a schematic view showing a cross sectional structure of a semiconductor substrate with respect to the NP (Nch-Pwell) diode element.

A name 376 indicates a name of a device recognition layer corresponding to the recognition layer 372. An LVS model name 377 indicates a name of the PN (Pch-Nwell) diode element recognition layer in the LVS rule file. A spice model name 378 indicates a circuit spice model name. A series degeneracy 379 defines whether the diode element is series-degenerated (TRUE) or not series-degenerated (FALSE) in the process of the LVS verification. Similarly, a parallel degeneracy 380 defines whether the transistor element is parallel-degenerated (TRUE) or not parallel-degenerated (FALSE) in the process of the LVS verification. A Tolerance 381 is an allowable tolerance (%) being applied to a comparison between an area size of the diode element of the circuit spice and an area size of the diode element of the layout spice in the process of LVS verification. A device parameter 382 is a field for being specified with a device parameter, but no specific specification is made with respect to the diode element.

A field 383 is a portion for the PN (Pch-Nwell) diode element recognition layer corresponding to the recognition layer 372, wherein a 89th layer is inputted as the layout data, and the recognition layer of the diode element is defined as DMK_DIOP in the LVS rule file. A circuit spice model name is PDIO, and the diode element is not series-degenerated (FALSE) in the process of the LVS verification. In the process of the LVS verification, the diode element is parallel-degenerated (TRUE). The allowable tolerance for the comparison between the area size of the diode element of the circuit spice and the area size of the diode element of the layout spice is specified to be 0.001%. Similar to the above, a field 384 is a portion for the NP (Nch-Pwell) diode element recognition layer corresponding to the recognition layer 374, wherein the 89th layer is inputted as the layout data, and the recognition layer is defined as DMK_DIOP, the circuit spice model name is PDIO, and the diode element is not series-degenerated (FALSE) but is parallel-degenerated (TRUE). The allowable tolerance is specified to be 0.001%.

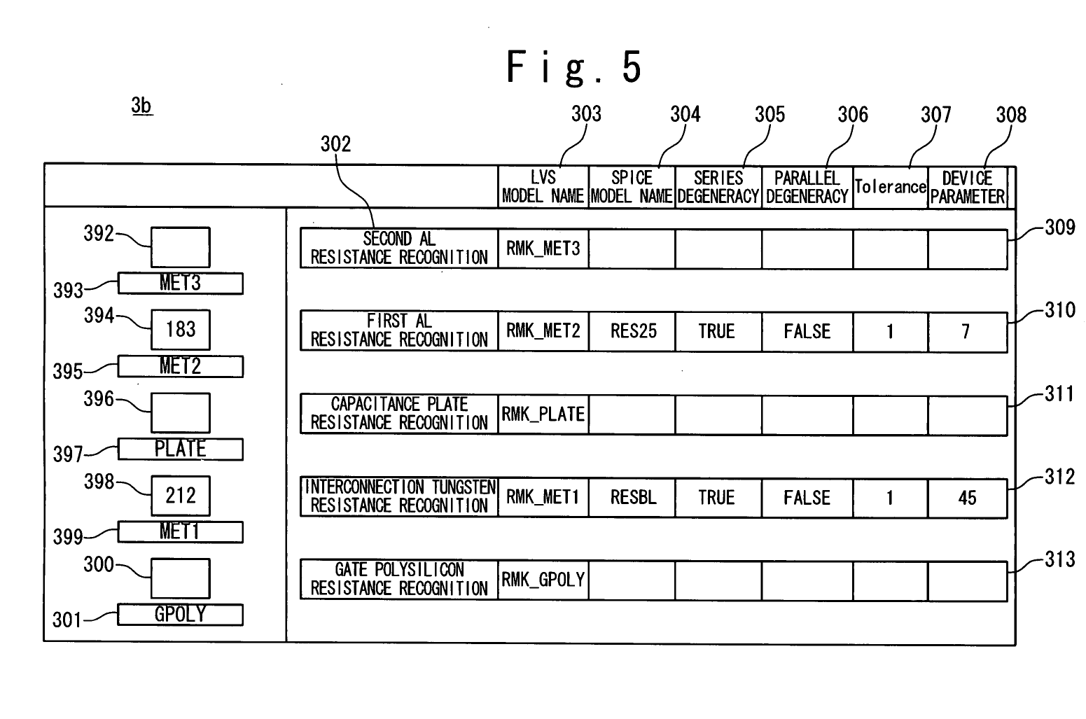

FIG. 5 is a table showing definitions of resistance elements as an example of the detailed configuration of the three-dimensional element definition file for elements other than the transistor elements, the capacitor elements, and diode elements. In this case, a portion remaining after removal of practical data (such as names and numeric values) from the three-dimensional element definition file 3b represents the example of the template for the resistance elements as three-dimensional elements.

In the three-dimensional element definition file 3b, resistance elements formed with respect to conductors being used as interconnection materials are defined. A recognition layer 392 is a recognition layer for recognizing the resistance element being formed of a second AL in the layout design. A recognition layer 393 indicates a name of the second AL in the LVS rule file. The respective configuration having the recognition layer 392 on the recognition layer 393 indicates that even in the case of actual layout design, the resistance element recognition layer of the second AL is overlaid on the layout data of the second AL. However, in the example of the three-dimensional element definition file 3b, nothing is inputted in the portion of the recognition layer 392. This case indicates that there is no corresponding resistance element of the second AL. Thereafter, in a manner similar to the above, definitions are made as follows. A resistance element related to a first AL is defined by the combination of recognition layers 394 and 395. A resistance element related to a capacitance plate is defined by the combination of recognition layers 396 and 397. A resistance element related to an interconnection tungsten is defined by the combination of recognition layers 398 and 399. A resistance element related to a gate polysilicon is defined by the combination of recognition layers 300 and 301. In the example of the three-dimensional element definition file 3b, a 183rd layer is inputted to the portion of the recognition layer 394. A 212th layer is inputted to the portion of the recognition layer 398. Therefore, it can be known that the resistance element of the first AL and the resistance element of the interconnection tungsten are placed on the layout data.

A name 302 indicates a name of a device recognition layer corresponding to the recognition layer 392. An LVS model name 303 indicates a name of the second-AL resistance recognition layer in the LVS rule file. A spice model name 304 indicates a circuit spice model name. A series degeneracy 305 defines whether the second-AL resistance element is series-degenerated (TRUE) or not series-degenerated (FALSE) in the process of the LVS verification. Similarly, a parallel degeneracy 306 defines whether the second-AL resistor element is parallel-degenerated (TRUE) or not parallel-degenerated (FALSE) in the process of the LVS verification. A Tolerance 307 is an allowable tolerance (%) being applied to a comparison between a resistance value (Rvalue) of the second-AL resistance element of the circuit spice and a resistance value (Rvalue) of the second-AL resistance element of the layout spice in the process of the LVS verification. A device parameter 308 is a portion for specifying a second AL device parameter (Ω/sq).

In fields 309 to 313, the items from the circuit spice model name 304 to the device parameter 308 are sequentially defined with respect to the resistance element of the second AL, the resistor element of the first AL, the resistance element of the capacitance plate, the resistance element of the interconnection tungsten, and the resistance element of the gate polysilicon. In the example of the three-dimensional element definition file 3b, the resistance element of the first AL and the resistance element of the interconnection tungsten are defined. In the field 310, the LVS model name 303 is specified as RMK MET2 in the LVS rule file. The circuit spice model name 304 with respect to the resistance element of the first AL is defined as RES25. Additionally, it is defined such that in the process of the LVS verification, the first AL resistance element is series-degenerated (305: TRUE), but is not parallel-generated (306: FALSE). The allowable tolerance for the comparison between the resistance value (Rvalue) of the first AL resistance element of the circuit spice and the resistance value (Rvalue) of the first AL resistance element of the layout spice is defined to be 1%. The device parameter of the first AL is defined to be 7 (Ω/sq). Similarly, in the field 312, the LVS model name 303 is specified as RMK MET1 in the LVS rule file. The circuit spice model name 304 with respect to the interconnection tungsten resistance element is defined as RESBL. Additionally, it is defined therein such that in the process of the LVS verification, the interconnection tungsten resistance element is series-degenerated (305: TRUE), but is not parallel-generated (306: FALSE). The allowable tolerance for the comparison between the resistance value (Rvalue) of the interconnection tungsten resistance element of the circuit spice and the resistance value (Rvalue) of the interconnection tungsten resistance element of the layout spice is defined to be 1%. The device parameter of the interconnection tungsten is defined to be 45 (Ω/sq).

For the name of the resistance recognition layer of the LVS model name 303 in the LVS rule file, the name is defined from the beginning despite of whether a resistance recognition layer exists or not. When the recognition layer exists, the name of that resistance recognition layer is used in the LVS rule file. In the example of the three-dimensional element definition file 3b, the first AL resistance element and the interconnection tungsten resistance element are defined, and the RMK_MET2 and RMK_MET1 corresponding to those recognition layers are used in the LVS rule file.

With the three-dimensional element definition file 3a-3b, the three-dimensional structures of the device elements can be defined in addition to the conventionally known planar (two-dimensional) definition.

Differences of the present invention from the conventional example will be described below with reference to an example case of diode elements.

In the case of conventional planar (two-dimensional) definitions, if a diode element is described only with the anode and the cathode, the three-dimensional relation between the anode and the cathode in device structure with respect to the surface of the semiconductor substrate cannot be defined. On the other hand, in the three-dimensional element definition file 3a, the anode and cathode and even an external BULK material are defined corresponding to the actual device structure.

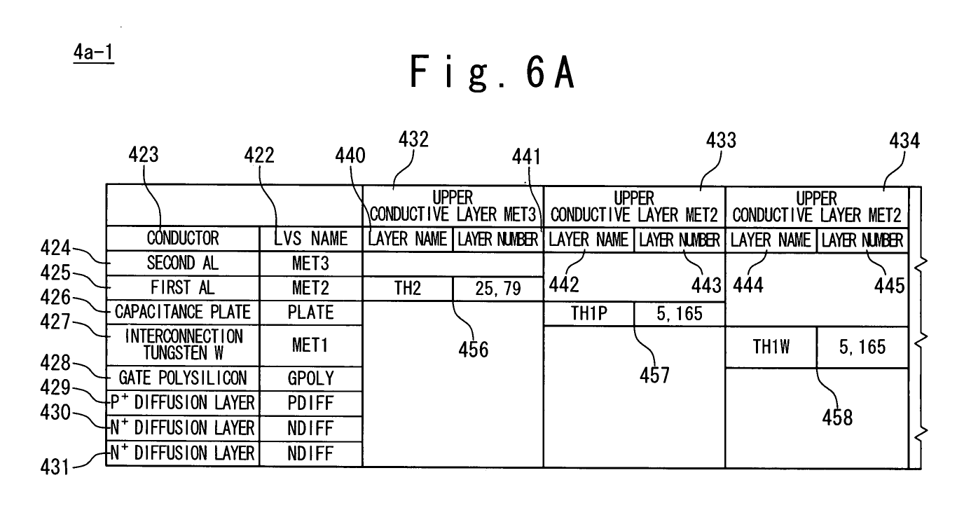

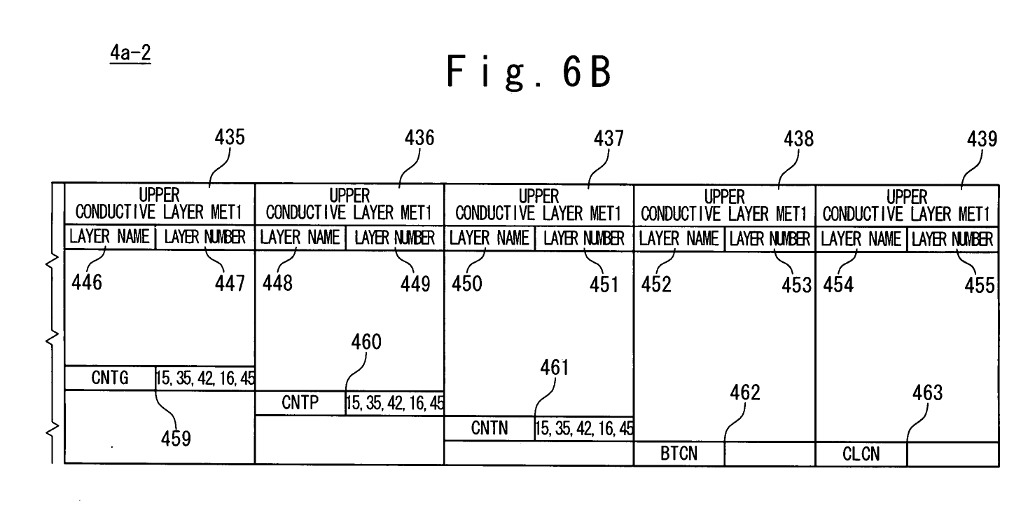

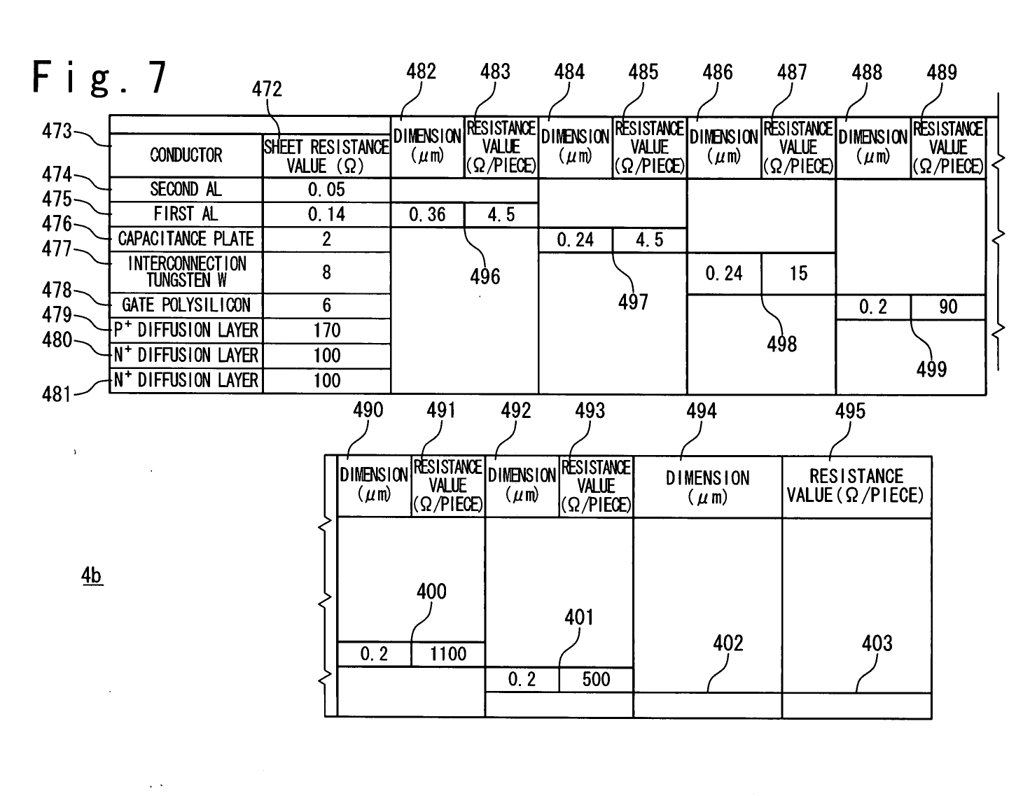

FIGS. 6A, 6B and 7 are tables showing an example of a detailed configuration of three-dimensional contact connection definition files. In this case, a portion remaining after removal of practical data (such as names and numeric values) from the three-dimensional contact connection definition file represents an example of a three-dimensional contact connection template.

The three-dimensional contact connection definition file is mainly configured of the following two portions. As shown in the example of the three-dimensional contact connection definition file 4a (4a-1 of FIG. 6a and 4a-2 of FIG. 6B), in the first portion, types of the upper conductor and lower conductor connected by contacts are defined. Additionally, names of the contacts in the LVS rule file and layout layers in the process of the layout design are indicated therein. As shown in the example of the three-dimensional contact connection definition file 4b (FIG. 7), the second portion indicates dimensions of the contacts and sheet resistance values of the conductors.

With reference to FIGS. 6A and 6B, in the example of the three-dimensional contact connection definition file 4a, types of upper conductors connected to the contacts are defined in fields 432 to 439. In addition, types of lower conductors connected to the contacts are defined in fields 424 to 431.

For the lower conductors, the fields 424 to 431 following a conductor 423 indicate names of the lower conductors. The fields 424 to 431 are defined sequentially (in the descending order) from the conductor existing in an upper position of the cross sectional structure of the semiconductor substrate. It is indicated that a second AL 424, a first AL 425, a capacitance plate 426, a interconnection tungsten 427, and a gate polysilicon 428 exists sequentially from the upper position of the cross sectional structure of the semiconductor substrate. However, a P⁺ diffusion layer 429, an N⁺ diffusion layer 430, and N⁺ diffusion layer 431 exist in a position lower than the gate polysilicon 428 in the cross sectional structure of the semiconductor substrate, and are placed in the positional relation of the same height as one another. The N⁺ diffusion layers are defined with the two types of the N⁺ diffusion layers 430 and 431 for the reason that there are two types of contacts to be connected to the N⁺ diffusion layers. They are separated to be independently defined. Fields following an LVS name 422 indicate names of the lower conductors corresponding to the names of the lower conductors in the LVS rule file.

For the upper conductors, the fields 432 to 439 indicate names of the upper conductors. The names are sequentially (from left to right) from the upper-positioned conductor in the cross sectional structure of the semiconductor substrate. In an upper conductive layer MET3 (432), a highest second AL (=LVS name: MET3) is defined. Subsequently, in a respective upper conductive layer MET2 (433) and upper conductive layer MET2 (434), a first AL (=LVS name: MET2) is defined. In this case, the first AL (MET2) is defined two times for the reason that there are two types of contacts for connection to the first AL (MET2). They are separated to be independently defined. Similarly, in each of the items of from an upper conductive layer MET1 (435) to an upper conductive layer MET1 (439), interconnection tungsten (=LVS name: MET1) is defined.

Fields 440 to 463 define contacts for connecting between types of the lower conductors and types of upper conductors. The types of the lower conductors are connected to the contacts and are defined in the items from the second AL 424 to the N⁺ diffusion layer 431. The types of upper conductors are connected to the contacts and are defined in the items of from the upper conductive layer MET3 (432) to the upper conductive layer MET1 (439). The fields 440 to 455 indicate items (layer names and layer numbers). The contact 456 is defined as a contact for connecting between an upper second AL (MET3) and a lower first AL (MET2). TH2 is defined as the layer name 440 in the LVS rule file, and a 25th layer and a 79th layer are defined as the layer number 441 in the layout design. The contact 457 is defined as a contact for connecting between an upper first AL (MET2) and a lower capacitance plate (=LVS name: PLATE). TH1P is defined as the layer name 442 in the LVS rule file, and a 5th layer and a 165th layer are defined as the layer number 443 in the layout design. The contact 458 is defined as a contact for connecting between an upper first AL (MET2) and a lower interconnection tungsten (MET1). TH1W is defined as the layer name 444 in the LVS rule file, and the 5th layer and the 165th layer are defined as the layer number 445 in the layout design. The contact 459 is defined as a contact for connecting between an upper interconnection tungsten (MET1) and a lower gate polysilicon (=LVS name: GPOL). CNTG is defined as the layer name 446 in the LVS rule file, and a 15th layer, a 35th layer, a 42nd layer, a 16th layer, and a 45th layer are defined as the layer number 447 in the layout design. The contact 460 is defined as a contact for connecting between an upper interconnection tungsten (MET1) and a lower P⁺ diffusion layer (=LVS name: PDIFF). CNTP is defined as the layer name 448 in the LVS rule file, and the 15th layer, the 35th layer, the 42nd layer, the 16th layer, and the 45th layer are defined as the layer number 449 in the layout design. The contact 461 is defined as a contact for connecting between the upper interconnection tungsten (MET1) and a lower N⁺ diffusion layer (=LVS name: NDIFF). CNTN is defined as the layer name 450 in the LVS rule file, and the 15th layer, the 35th layer, the 42nd layer, the 16th layer, and the 45th layer are defined as the layer number 451 in the layout design.

In semiconductor processing, there are special contacts (hereafter referred to as multi-layer contact) that enable to connect the lower conductor to the upper conductor at the same portion in the layout through two contact process steps. The multi-layer contact is exemplified by the contacts 462 and 463. The multi-layer contact (462+463) connects the upper interconnection tungsten (MET1) to the lower N⁺ diffusion layer (=LVS name: NDIFF). The contact 462 indicates the upper contact of the multi-layer contact. BTCN is defined as the layer name 452 in the LVS rule file, and the layer number is defined to be a layer number 153 in the layout design. The contact 463 indicates the lower contact of the lamination contact. CLCN is defined as the layer name 454 in the LVS rule file, and the layer number is defined to be a layer number 155 in the layout design. In the example of the three-dimensional contact connection definition file 4a, the layer numbers 153 and 155 are both blanks. This case indicates that no multi-layer contact exists.

Referring to FIG. 7, in the example of the three-dimensional contact connection definition file 4b, a conductor 473 and following fields 474 to 481 are equally configured corresponding to the configuration of the conductor 423 and following fields 424 to 431. That is, the same names of lower conductors as those in FIGS. 6A and 6B. Field following a sheet resistance value (Ω) 472 correspond to the names of the lower conductors and define sheet resistance values (Ω/sq) of the lower conductors being connected by contacts in units of the type. For example, the first AL 475 is the same as the first AL 425 (MET2), and the sheet resistance value thereof is 0.14 (Ω/sq).

In Fields 482 to 499 and 400 to 403, in units of the type, the dimension (μm) of one side of the contact (482, 484, 486, 488, 490, 492, 494) and the resistance value (Ω/piece) of the contact (483, 485, 487, 489, 491, 493, 495) are defined, respectively. The each of the contacts are defined based on the items from the second AL 474 to the N⁺ diffusion layer 481. Particularly, the fields 496 to 499 and 400 to 403 correspond to 456 to 463 of FIGS. 6A and 6B, respectively.

The contact 496 is a contact (TH2) for connecting between the upper second AL (MET3) and the lower first AL (MET2). The one-side dimension is 0.36 (μm), and the one-contact resistance value is 4.5 (Ω/piece). The contact 497 is a contact (THiP) for connecting between the upper first AL (MET2) and the lower capacitance plate (PLATE). The one-side dimension is 0.24 (μm), and the one-contact resistance value is 4.5 (Ω/piece). The contact 498 is a contact (TH1W) for connecting between the upper first AL (MET2) and the lower interconnection tungsten (MET1). The one-side dimension is 0.24 (μm), and the one-contact resistance value is 15 (Ω/piece). The contact 499 is a contact (CNTG) for connecting between the upper interconnection tungsten (MET1) and the lower gate polysilicon (GPOLY). The one-side dimension is 0.2 (μm), and the one-contact resistance value is 90 (Ω/piece). The contact 400 is a contact (CNTP) for connecting between the upper interconnection tungsten (MET1) and the P⁺ diffusion layer (PDIFF). The one-side dimension is 0.2 (μm), and the one-contact resistance value is 1100 (Ω/piece). The contact 401 is a contact (CNTN) for connecting between the upper interconnection tungsten (MET1) and the N⁺ diffusion layer (NDIFF). The one-side dimension is 0.2 (μm), and the one-contact resistance value is 500 (Ω/piece);

In connection with the multi-layer contact configured of the contacts 162 and 163 of FIGS. 6A and 6B, the one-side dimension (μm) of the multi-layer contact is defined in a field 402 and one contact resistance value (Ω/piece) is defined in a field 403 in FIG. 7. However, in the example of FIGS. 6A and 6B, the layer number 153 of the upper contact 162 of the multi-layer contact and the layer number 155 of the lower contact 163 of the multi-layer contact are both blanks, wherein no multi-layer contact exists. Accordingly, in FIG. 7, also the field 402 indicative of the one-side dimension (μm) of the multi-layer contact and the field 403 indicative of the one-multi-layer-contact resistance value (Ω/piece) are both blanks.

As described above, the three-dimensional contact connection definition files 4a to 4b defines the connection relations in the upper-lower direction with respect to configurations related to the connections such as VIAs and contacts. In addition, the definition files 4a to 4b defines, for example, the structures (ex. : dimensions and quantities) and properties (ex.: resistance values) thereof. Thereby, the three-dimensional connection relations and structures can be defined in addition to the conventionally known planar (two-dimensional) definition.

In practical semiconductor processing, through-holes each connecting between the upper first AL (MET2) in the upper-base and the lower capacitance plate (PLATE) or the lower interconnection tungsten (MET1) in the lower-base are formed at the same time in one semiconductor processing step.

In this case, in the case of conventionally known planar (two-dimensional) definition whereby to merely execute LVS verification, only electrical connectivity between the circuit schematic and the layout is checked. Therefore, it is not necessary to separate two types of through-holes each for connecting between the upper first AL (MET2) and the lower capacitance plate (PLATE) or the lower interconnection tungsten (MET1) in the logic type from each other. That is, in the above-described case, it is sufficient to define one through-hole as the two types of through-holes.

However, an important matter for the execution of the actual-load extraction is that even in the case that the three-dimensional structures of the through-holes are different from each other, the parasitic capacitance values around the through-holes are different from one another and also the resistance values of the through-holes are different from each other depending on the material quality of the lower-base conductor. Therefore, the through-holes need to be separated from each other in logic type. That is, even in the case of the same through-holes, the three-dimensional structures are different from one another, and the parasitic capacitance values and parasitic resistance values are different from one another between the case of the lower base of the lower capacitance plate (PLATE) and the case of the lower-base of the upper interconnection tungsten (MET1). As such, the through-holes need to be separated from each other in the logic type.

Based on the concepts similar to the above, three types of the contacts each for connecting between the upper interconnection tungsten (MET1) and the gate polysilicon (GPOLY) or the lower P⁺ diffusion layer (PDIFF) or the lower N⁺ diffusion layer (NDIFF) need to be separated from one another in logic type.

As means for accomplish the above, the above-described definition of the three-dimensional contact connection definition files 4a to 4b is very effective, thereby to enable the logic types to easily be separated from one another.

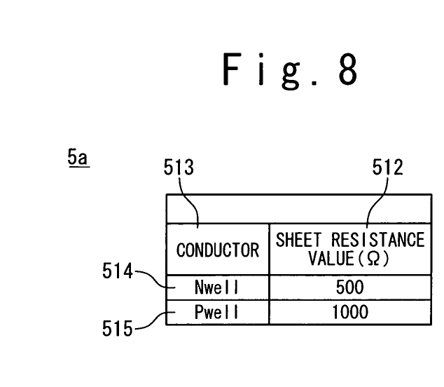

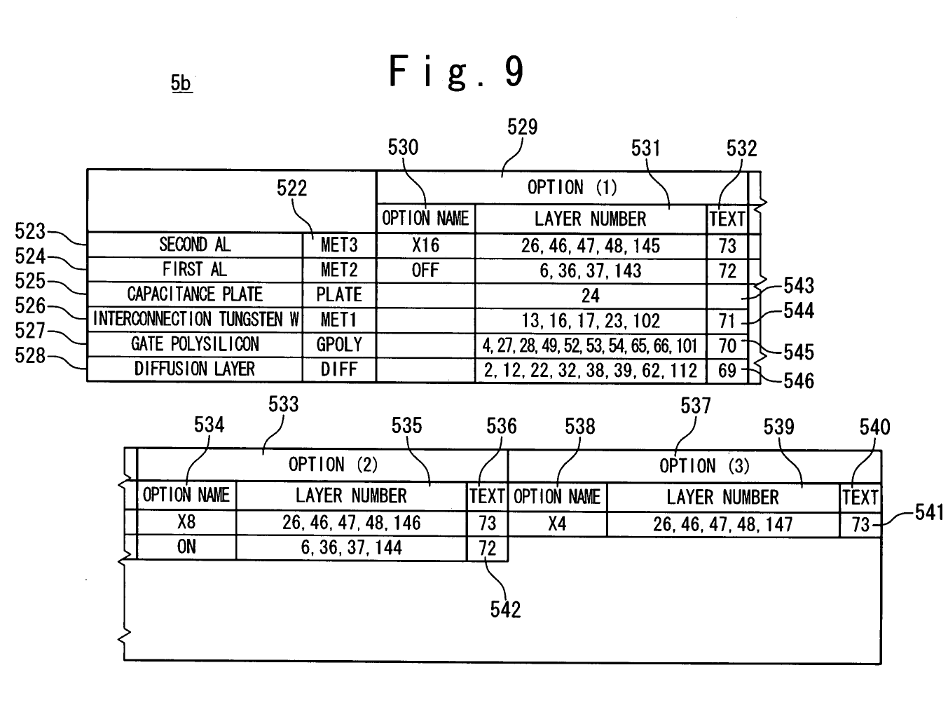

FIGS. 8 and 9 are tables showing an example of a detailed configuration of a conductive layer definition file. In this case, a portion remaining after removal of practical data (such as names and numeric values) from the conductive layer definition file represents an example of a conductive layer template.

The conductive layer definition file is mainly configured of the following two portions. As shown in the example of the conductive layer definition file 5a (FIG. 8), the first portion defines sheet resistance values of an N-well portion of a semiconductor substrate and a P-well portion thereof. As shown in the example of a conductive layer definition file 5b (FIG. 9), the second portion defines uniquely all process steps for conductive layers in semiconductor processing in the LVS rule file.

With reference to FIG. 8, in the example of the conductive layer definition file 5a, fields 514 and 515 following a conductor 513 indicate the conductor types. The fields following a sheet resistance value (Ω) 512 indicate sheet resistance values (Ω/sq) corresponding to the conductor types. That is, the sheet resistance value of the N-well 514 portion is 500 (Ω/sq), and the sheet resistance value of the P-well 515 portion is 1000 (Ω/sq).

In the example of the conductive layer definition file 5b, all the process steps for conductive layers in the semiconductor processing are defined and uniquely in an LVS rule file. A second AL process step 523 of the semiconductor processing is defined to be a MET3 process step in the field 522 in the LVS rule file. Definitions are similarly provided in the following fields. A first AL process step 524 of the semiconductor processing is defined to be a MET2 process step in the LVS rule file. A capacitance plate process step 525 of the semiconductor processing is defined to be a PLATE process step in the LVS rule file. A interconnection tungsten (W) process step 526 of the semiconductor processing is defined to be a MET1 process step in the LVS rule file. A gate polysilicon process step 527 of the semiconductor processing is defined to be a GPOLY process step in the LVS rule file. A diffusion layer process step 528 of the semiconductor processing is defined to be DIFF in the LVS rule file.

In fields 529 to 540, configurations of layer numbers, configurations of TEXT layers, and metal option changes (master slices) are defined in the LVS rule file for all the process steps for conductive layers in the semiconductor processing. More specifically, an option (1) 529 defines a first metal option change (master slice), and an option name 530 defines names of the first metal options. A layer number 531 defines layer number configurations regarding the first metal options in the process of the layout design. A TEXT 532 indicates TEXT layers being used in the first metal options in the layout design.

An option (2) 533 defines second metal option changes (master slices). An option name 534 defines names of the second metal options. A layer number 535 defines layer number configurations regarding the second metal options in the process of the layout design. A TEXT 536 indicates TEXT layers being used in the second metal options in the layout design.

An option (3) 537 defines third metal option changes (master slices). An option name 538 defines names of the third metal options. A layer number 539 defines layer number configurations regarding the third metal options in the process of the layout design. A TEXT 540 indicates TEXT layers being used in the third metal options in the layout design.

A field 541 indicates that the second AL (MET3 in the LVS rule file) of the semiconductor processing is configured of three metal option changes (master slices) A first metal option has the name X16, and the layer number configuration in the process of the layout design is formed of a 26th layer, 46th layer, 47th layer, 48th layer, and 145th layer. The TEXT layer in the layout design is a 73rd layer. A second metal option has the name X8, and the layer number configuration in the event of layout design is formed of the 26th layer, 46th layer, 47th layer, 48th layer, and 146th layer. The TEXT layer in the layout design is the 73rd layer. A third metal option has the name X4, and the layer number configuration in the event of layout design is formed of the 26th layer, 46th layer, 47th layer, 48th layer, and 147th layer. The TEXT layer in the layout design is the 73rd layer.

A field 542 indicates that the first AL (MET2) in the LVS rule file) of the semiconductor processing is configured of two metal option changes (master slices). A first metal option has the name OFF, and the layer number configuration in the process of the layout design is formed of a 6th layer, 36th layer, 37th layer, and 143rd layer. The TEXT layer in the layout design is a 72nd layer. A second metal option has the name ON, and the layer number configuration in the event of layout design is formed of the 6th layer, 36th layer, 37th layer, and 144th layer. The TEXT layer in the layout design is the 72nd layer.

A field 543 indicates that the capacitance plate (PLATE in the LVS rule file) of the semiconductor processing is configured of one metal option change (master slice). That is, it is indicated that no metal option change (master slice) exists. In this case, since no metal option change (master slice) exist, the corresponding item 530 is a blank. The layer number configuration in the process of the layout design is formed only of a 24th layer. Since no TEXT layer exists, corresponding item 532 is a blank.

A field 544 indicates that the interconnection tungsten (W) (ME1) in the LVS rule file of the semiconductor processing is configured of one metal option change (master slice). That is, it is indicated that no metal option change (master slice) exists. In this case, since no metal option change (master slice) exists, the corresponding item 530 is a blank. The layer number configuration in the process of the layout design is formed of a 13th layer, 16th layer, 17th layer, 23rd layer, and 102nd layer. The TEXT layer in the layout design is a 71st layer.

A field 545 indicates that the gate polysilicon (GPOLY) in the LVS rule file) of the semiconductor processing is configured of one metal option change (master slice). That is, it is indicated that no metal option change (master slice) exists. In this case, since no metal option change (master slice) exists, the corresponding item 530 is a blank. The layer number configuration in the event of layout design is formed of a 4th layer, 27th layer, 28th layer, 49th layer, 52nd layer, 53rd layer, 54th layer, 65th layer, 66th layer, and 101st layer. The TEXT layer in the layout design is a 70th layer.

A field 546 indicates that the diffusion layer (DIFF in the LVS rule file) of the semiconductor processing is configured of one metal option change (master slice). That is, it is indicated that no metal option change (master slice) exists. In this case, since no metal option change (master slice) exists, the corresponding item 530 is a blank. The layer number configuration in the process of the layout design is formed of a 2nd layer, 12th layer, 22nd layer, 32nd layer, 38th layer, 39th layer, 62nd layer, and 112th layer. The TEXT layer in the layout design is a 69th layer.

Thus, the relations with the conductive layers and layers can be clarified by the conductive layer definition file 5b.

Based on the templates corresponding to the above-described definition files shown in FIGS. 2 to 9 wherein the three-dimensional device data are explicitly described, the LVS rule files even considering the actual-load extraction are automatically generated. The LVS rule file is generated by the automatic LVS rule file generation program. By using the LVS rule files, the rules are described based on the three-dimensional device data, so that the actual-load extraction can be accomplished thereby to enable to parasitic elements to be extracted.

The following will again describe the differences between the mere LVS verification and the LVS verification for the purpose of executing the actual-load extraction.

When the LVS verification is merely executed, only electrical connectivity between a circuit schematic and a layout. Therefore, in the case of, for example, a conductor of same polysilicon, a gate portion of a transistor element, a polysilicon portion of a capacitor element, and a polysilicon portion of an interconnection do not need to be separated from one another in logic type. In this case, it is sufficient to define one polysilicon as the polysilicon.

However, in the LVS verification for the purpose of executing the actual-load extraction, even in the case of conductors of the same material, when the three-dimensional structures are different from one another, since the parasitic capacitance values are different from one another, the logic types need to be separated from one another. That is, even in the case of the conductors of the same polysilicon, since the gate portion of the transistor element, the polysilicon portion of the capacitor element, and the polysilicon portion of the interconnection are different from one another in the three-dimensional structure and parasitic capacitance value, the portions need to be separated from one another in the logic types.

In addition, in practical semiconductor processing, in the case that two types of through-holes each connecting between the upper first AL (MET2) and the lower capacitance plate (PLATE) or the lower interconnection tungsten (MET1) are formed at the same time in one semiconductor processing step, in the event of mere execution of the LVS verification based on the conventionally known planar (two-dimensional) definition, only the electrical connectivity between the circuit schematic and the layout is checked. Thus, the two types of through-holes each for connecting between the upper first AL (MET2) and the lower capacitance plate (PLATE) or the lower interconnection tungsten (MET1) do not need to be separated in the logic type from each other. That is, in the above-described case, it is sufficient to define one through-hole for the two types of through-holes.

However, in the LVS verification for the purpose of executing the actual-load extraction, even in the case of the same through-holes, when the three-dimensional structures are different from each other, the parasitic capacitance values around the through-holes are different from one another and also the resistance values of the through-holes are different from each other depending on the material quality of the lower-base conductor. For this reason, the through-holes need to be separated from each other in logic type.

More specifically, even in the case of the same through-holes, the three-dimensional structures are different from one another, and the parasitic capacitance values and parasitic resistance values are different from one another between the case of the lower capacitance plate (PLATE) and the case of the lower interconnection tungsten (MET1). As such, the through-holes need to be separated from each other in the logic type.

Based on the concepts similar to the above, the contacts each for connecting between the upper interconnection tungsten (MET1) and the lower gate polysilicon (GPOLY) or the lower P⁺ diffusion layer (PDIFF) or the lower N⁺ diffusion layer (NDIFF) need to be separated from one another in the logic type.

Thus, the templates and definition files according thereto based on the present invention described above are capable of explicitly defining the three-dimensional structures and the three-dimensional positional relationships, so that the actual-load extraction can be accomplished thereby to enable to parasitic elements to be extracted.

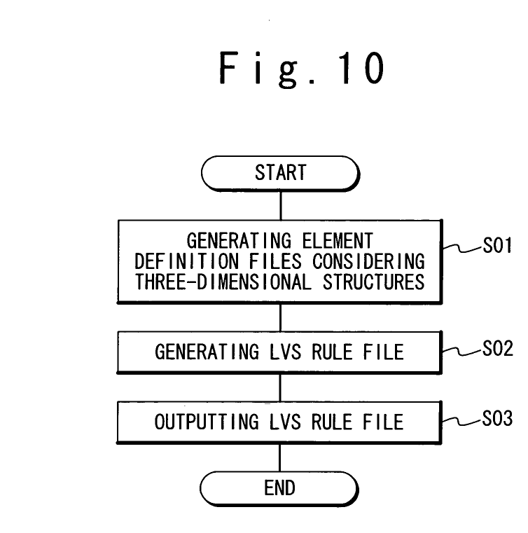

An operation of the embodiment of the method for automatic LVS rule file generation according to the present invention will be described below with reference to the attached drawings. FIG. 10 is a flowchart showing the operation of the embodiment of the automatic LVS rule file generation according to the present invention.

(1) Step S01

In the step S01 of the three-dimensional-structure considering element definition file generation, the definition file generating unit 11 displays the templates (described in conjunction with FIGS. 3 to 9) stored in the template storage unit 13 on the display device. The user inputs predetermined data to the displayed templates. The predetermined data may be obtained by using, for example, a method of automatically obtaining data stored in a storage device (not shown) or a method of automatically obtaining from the outside through communication. The definition file generating unit 11 generates element definition files based on the obtained predetermined data. The element definition files in this case correspond to the element definition files considering the three-dimensional structures, which are exemplified by FIGS. 3 to 9. The element definition files may be stored in the definition file storage unit 14.

(2) Step S02

In the step S02 of the LVS rule file generation, the rule file generating unit 12 translates the parameters into the LVS verification rules based on the element definition files considering the three-dimensional structures generated in the step S01 (or stored in the definition file storage unit 14) to generate the LVS rule file for the actual-load extraction (parasitic element extraction).

(3) Step S03

In the step S03 of the LVS rule file output, the rule file generating unit 12 outputs the LVS rule file for the actual-load extraction (parasitic element extraction) generated in the step S02. The LVS rule file is outputted to, for example, a display device or predetermined storage device.

According to the processes described above, in accordance with the element definition files being used as input data, the LVS rule file for the parasitic element extraction is generated by the automatic LVS rule file generation program for the parasitic element extraction (actual-load extraction).

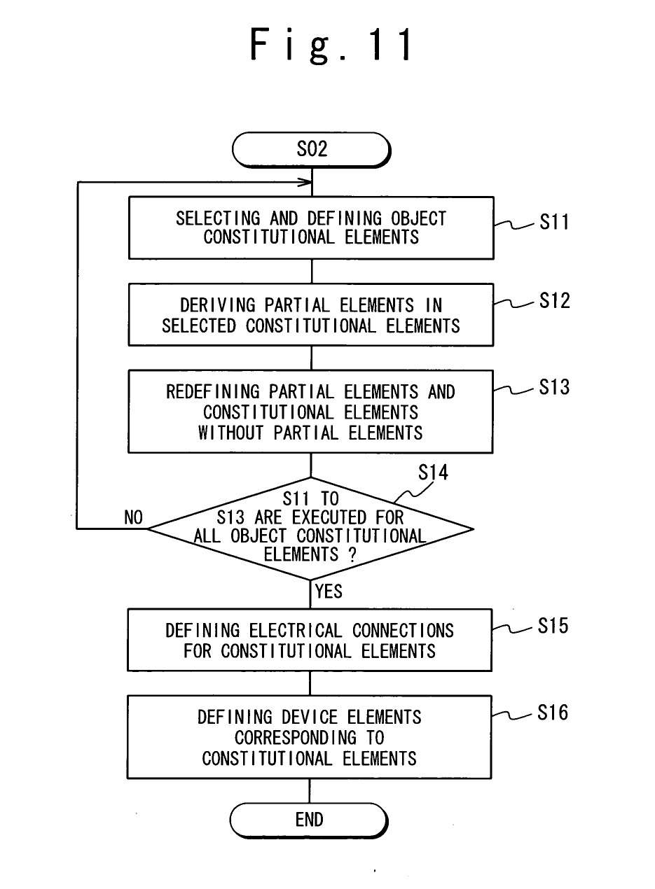

The generation of the LVS rule file in the step S02 will be described in more detail here with reference to the accompanying drawings. FIG. 11 is a flowchart showing the operation in step S02. In each step, description will be made with reference to the polysilicon as an example. However, the operation (before the step S11) of the LVS process object data specifying unit 12-1 and the data process option specifying unit 12-2, and the operation (after the step S16) of the LVS process result output specifying unit 12-7 are similar to the conventional operations, so that descriptions thereof are omitted herefrom.

The “Definition” in the operation refers to translation of parameters into LVS verification rules corresponding to the grammar (syntax) of LVS verification tools.

(1) Step S11

Based on the element definition files generated in the step S01 (or stored in the definition file storage unit 14), the layout data input layer defining unit 12-3 selects predetermined parameters of object constitutional elements of the semiconductor device, and then defines the constitutional elements. The object constitutional elements are already specified by the LVS process object data specifying unit 12-1. The list of the object constitutional elements are stored in a storage unit (not shown) portion. Items in which object constitutional elements are explicitly described may be added in the element definition files.

For example, in the definition portions for conductors, parameters related to polysilicon are selected from the element definition files and defined as polysilicon, which is the object constitutional elements.

Other constitutional elements are exemplified by the diffusion layer, the interconnection tungsten, the capacitance plate, the first AL, and the second AL.

(2) Step S12

Based on the element definition files, the layout data pattern logical processing unit 12-4 derives partial elements of device elements in the selected constitutional elements. The partial elements related to the polysilicon are gate portions of transistor elements and polysilicon portions of capacitor elements. For other example, partial elements related to the diffusion layers include source/drain portions of a transistor element, p/n layer portions of a diode element, collector/base/emitter portions of a bipolar element, and gate/source/drain portions of a junction field-effect transistor (JFET).

For example, based on the element definition files, the gate portions of the selected polysilicon transistor elements and the polysilicon portions of the capacitor elements are derived.

(3) Step S13

The layout data pattern logical processing unit 12-4 executes graphical-pattern logical operation to remove the partial elements derived in the step S12 from the constitutional element defined in the step S11. That is, the partial elements are separated in logic type as shapes different from one another. Then, the partial elements derived in the step S12 and the constitutional elements after removal of the derived partial elements are redefined.

For example, the gate portion of the transistor element and the polysilicon portion of the capacitor element are removed from the defined polysilicon, and those portions are separated as different shapes from one another. Then, the partial element derived as the gate portion of the transistor element is redefined to be the gate portion of the transistor element. The partial element derived as the polysilicon portion of the capacitor element is redefined to be the polysilicon portion of the capacitor element. The remaining portion is redefined to be the polysilicon portion of the interconnection. At this stage, the polysilicon are completely separated into the gate portion of the transistor element, the polysilicon portion of the capacitor element, and the polysilicon portion of the interconnection.

(4) Step S14 In the case that steps S11 to S13 are being executed for all the object constitutional elements (step 14: Yes), the layout data pattern logical processing unit 12-4 proceeds to step S15. In the case that the steps are not being executed (step 14: No), the unit proceeds to step S11.

(5) Step S15

The layout data pattern connection defining unit 12-5 defines electrical connections for the defined (and/or redefined) constitutional elements in defined portions for connections.

For example, the defined gate portion of the transistor element, the defined polysilicon portion of the capacitor element, and the defined polysilicon portion of the interconnection are defined to be electrically connected to one another.

In the step S13, the polysilicons are completely separated into the gate portion of the transistor element, the polysilicon portion of the capacitor element, and the polysilicon portion of the interconnection. However, in an actual semiconductor device, such portions are electrically connected to one another, so that it is defined in the defined portions for connection that the portions are electrically connected to one another. That is, while the shapes are separated in the logic type, electrically connection is remained.

(6) Step S16

The net list comparing unit 12-6 associates the constitutional elements of the layout data with those of the circuit schematic data. More specifically, the net list comparing unit 12-6 associates elements constituted of partial elements of the layout data (ex.: layout net list data) with device elements of the circuit schematic data (ex.: circuit net list data), thereby to perform definition thereof.

For example, the following is exemplified as syntax for defining the transistor element:
A=B C D E F
Where,
A=a transistor name in the circuit net list;
B=a transistor name in the layout net list;
C=a drain name as a result of the layout data graphical-pattern operation (S13);
D=a gate polysilicon name as a result of the layout data graphical-pattern operation (S13);
E=a source name as a result of the layout data graphical-pattern operation (S13); and
F=a BULK name as a result of layout data graphical-pattern operation (S13).

With the names, the data of the device element are associated with the data of the partial elements.

By the process described above, the LVS rule file including the three-dimensional structures and three-dimensional positional relationships in the semiconductor device can be automatically generated. The LVS rule file is generated by even considering the actual-load extraction, so that the extraction of parasitic elements can easily be accomplished.

Ordinarily, in the defined portion for the conductor, the operation terminates at, for example, the step of merely defining polysilicon. However, according to the operation described above, the polysilicon are separated into the gate portion of the transistor element, the polysilicon portion of the capacitor element, and the polysilicon portion of the interconnection, the electrical connection relations thereof are maintained, whereby they can be grasped as devices on the actual semiconductor device.

In the LVS verification for the purpose of executing the actual-load extraction, even in the case of conductors of the same material, when the three-dimensional structures are different from one another, since the parasitic capacitance values are different from one another, the logic types need to be separated from one another. That is, even in the case of the conductors of the same polysilicon, since the gate portion of the transistor element, the polysilicon portion of the capacitor element, and the polysilicon portion of the interconnection are different from one another in the three-dimensional structure and parasitic capacitance value, the portions need to be separated from one another in the logic types.

In addition, in practical semiconductor processing, in the case that two types of through-holes each connecting between the upper first AL (MET2) and the lower capacitance plate (PLATE) or the lower interconnection tungsten (MET1) are formed at the same time in one semiconductor processing step, in the LVS verification for the purpose of executing the actual-load extraction, similar to the above, even in the case of the same through-holes, when the three-dimensional structures are different from each other, the parasitic capacitance values around the through-holes are different from one another and also the resistance values of the through-holes are different from each other depending on the material quality of the lower-base conductor. For this reason, the through-holes need to be separated from each other in logic type. More specifically, even in the case of the same through-holes, the-three-dimensional structures are different from one another, and the parasitic capacitance values and parasitic resistance values are different from one another between the case of the lower capacitance plate (PLATE) and the case of the lower interconnection tungsten (MET1). As such, the through-holes need to be separated from each other in the logic type.

Based on the concepts similar to the above, the contacts each for connecting between the upper interconnection tungsten (MET1) and the lower gate polysilicon (GPOLY) or the lower P⁺ diffusion layer (PDIFF) or the lower N⁺ diffusion layer (NDIFF) need to be separated from one another in the logic type.

According to the present invention, based on the templates and definition files in which the three-dimensional device data are explicitly described, the LVS rule file, which even considers the actual-load extraction, for the parasitic element extraction can be automatically generated.

It is apparent that the present invention is not limited to the above embodiment, that may be modified and changed without departing form the scope and spirit of the invention.

1. An automatic LVS rule file generation apparatus comprising:
a definition file generating unit which generates definition files used for a layout verification based on first data and templates that are used for said layout verification in a layout design of a semiconductor apparatus; and
a rule file generating unit which automatically generates a LVS rule file based on said definition rule files,
wherein said templates includes first parameters indicating three-dimensional structures of said semiconductor apparatus,
said definition files includes second data with respect to said first parameters.

2. The automatic LVS rule file generation apparatus according to claim 1, wherein said three-dimensional structures includes at least one of three-dimensional structures of elements of said semiconductor apparatus and three-dimensional position relations among said elements.

3. The automatic LVS rule file generation apparatus according to claim 1, wherein said rule file generating unit automatically generates said LVS rule file by translating said second data of said definition files into rules for said layout design.

4. The automatic LVS rule file generation apparatus according to claim 3, wherein said rule file generating unit includes:
a first defining unit which selects second parameters of predetermined constitutional elements of said semiconductor apparatus from said first parameters, and defines said constitutional elements based on said second parameters,
a pattern logical processing unit which derives partial elements of said constitutional elements based on said definition files, and redefines said partial elements and said constitutional elements from which said partial elements are removed,
a second defining unit which defines electrical connections among said redefined partial elements and said redefined constitutional elements, and
a comparing unit which associates said redefined partial elements and said redefined constitutional elements with devices in circuit schematics of said semiconductor apparatus.

5. The automatic LVS rule file generation apparatus according to claim 1, wherein said first parameters includes third parameters regarding regions of ion implantation processes of said semiconductor apparatus and fourth parameters regarding devices of said semiconductor apparatus specified by said ion implantation processes.

6. The automatic LVS rule file generation apparatus according to claim 1, wherein said first parameters includes fifth parameters regarding conductor layers, master slice layers and text layers for LVS verification of said semiconductor apparatus.

7. A template for an automatic LVS rule file generation, wherein said template is used for generating a LVS rule file that indicates a rule for a layout verification of a layout design of a semiconductor apparatus, said template comprising:
at least one of first parameter fields which are used for inputting data regarding three-dimensional structures of elements of said semiconductor apparatus and second parameter fields which are used for inputting data regarding three-dimensional position relations among said elements; and
third parameter fields which are used for inputting data regarding two-dimensional structures of elements of said semiconductor apparatus.

8. The template for an automatic LVS rule file generation according to claim 7, further comprising:
fourth parameter fields which are used for inputting data regarding regions of ion implantation processes of said semiconductor apparatus; and
fifth parameter fields which are used for inputting data regarding devices of said semiconductor apparatus specified by said ion implantation processes.

9. The template for an automatic LVS rule file generation according to claim 7, further comprising:
sixth parameter fields which are used for inputting data regarding conductor layers, master slice layers and text layers for LVS verification of said semiconductor apparatus.

10. A method for an automatic LVS rule file generation comprising:
(a) generating definition files used for a layout verification based on first data and templates that are used for said layout verification in a layout design of a semiconductor apparatus; and
(b) generating automatically a LVS rule file based on said definition rule files,
wherein said templates includes first parameters indicating three-dimensional structures of said semiconductor apparatus,
said definition files includes second data with respect to said first parameters.

11. The method for an automatic LVS rule file generation according to claim 10, wherein said three-dimensional structures includes at least one of three-dimensional structures of elements of said semiconductor apparatus and three-dimensional position relations among said elements.

12. The method for an automatic LVS rule file generation according to claim 10, wherein said step (b) includes:
(b1) generating said LVS rule file by translating said second data of said definition files into rules for said layout design.

13. The method for an automatic LVS rule file generation according to claim 12, wherein said step (b1) includes:
(b11) selecting second parameters of predetermined constitutional elements of said semiconductor apparatus from said first parameters, and defining said constitutional elements based on said second parameters,
(b12) deriving partial elements of said constitutional elements based on said definition files, and redefining said partial elements and said constitutional elements from which said partial elements are removed,
(b13) defining electrical connections among said redefined partial elements and said redefined constitutional elements, and
(b14) associating said redefined partial elements and said redefined constitutional elements with devices in circuit schematics of said semiconductor apparatus.

14. The method for an automatic LVS rule file generation according to claim 10, wherein said first parameters includes third parameters regarding regions of ion implantation processes of said semiconductor apparatus and fourth parameters regarding devices of said semiconductor apparatus specified by said ion implantation processes.

15. The method for an automatic LVS rule file generation according to claim 10, wherein said first parameters includes fifth parameters regarding conductor layers, master slice layers and text layers for LVS verification of said semiconductor apparatus.

16. A computer-readable medium comprising code that, when executed, causes a computer to perform the following:
(a) generating definition files used for a layout verification based on first data and templates that are used for said layout verification in a layout design of a semiconductor apparatus; and
(b) generating automatically a LVS rule file based on said definition rule files,
wherein said templates includes first parameters indicating three-dimensional structures of said semiconductor apparatus,
said definition files includes second data with respect to said first parameters.

17. The computer-readable medium according to claim 16, wherein said three-dimensional structures includes at least one of three-dimensional structures of elements of said semiconductor apparatus and three-dimensional position relations among said elements.

18. The computer-readable medium according to claim 16, wherein said step (b) includes:
(b1) generating said LVS rule file by translating said second data of said definition files into rules for said layout design.

19. The computer-readable medium according to claim 18, wherein said step (b1) includes:
(b11) selecting second parameters of predetermined constitutional elements of said semiconductor apparatus from said first parameters, and defining said constitutional elements based on said second parameters,
(b12) deriving partial elements of said constitutional elements based on said definition files, and redefining said partial elements and said constitutional elements from which said partial elements are removed,
(b13) defining electrical connections among said redefined partial elements and said redefined constitutional elements, and
(b14) associating said redefined partial elements and said redefined constitutional elements with devices in circuit schematics of said semiconductor apparatus.

20. The computer-readable medium according to claim 16, wherein said first parameters includes third parameters regarding regions of ion implantation processes of said semiconductor apparatus and fourth parameters regarding devices of said semiconductor apparatus specified by said ion implantation processes.

21. The computer-readable medium according to claim 16, wherein said first parameters includes fifth parameters regarding conductor layers, master slice layers and text layers for LVS verification of said semiconductor apparatus.
